(19) United States
(12) Patent Application Publication
(10) Pub. No.: US 2006/0214023 A1
(43) Pub. Date: Sep. 28, 2006

(54) Combined turret and oscillator irrigation devices

(76) Inventors: Timothy Scott Collins, Salt Lake City, UT (US); Jeff Paul Maughan, Bountiful, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 11/087,172

(22) Filed: Mar. 23, 2005

(51) Int. Cl. B05B 3/16

(52) U.S. Cl. 239/242; 239/381; 239/394

(57) ABSTRACT

Multi-functional irrigation devices and methods for using these devices in irrigation are described. The irrigation devices of the invention contain a part that operates substantially similar to a turret sprinkler and another part that operates substantially similar to an oscillator sprinkler. The device contains a mechanism for switching function between the turret part and the oscillating part. The irrigation devices are thereby able to exhibit two modes of irrigation which can be used alternatively, saving the user time, effort, and costs.

### FIELD OF THE INVENTION

The invention generally relates to irrigation devices and methods for using such devices. More particularly, the invention relates to irrigation devices that have multiple functions and methods for using such devices for different types of irrigation. Even more particularly, the invention relates to irrigation devices that can be used both as a turret sprinkler and as an oscillator sprinkler for watering lawns.

### BACKGROUND OF THE INVENTION

There are many types of irrigation devices known in the art. See, for example, U.S. Pat. Nos. D500,122 and D498,513, the disclosures of which are incorporated herein by reference. One of the most common types of irrigation devices are sprinklers that distribute water over an area with a specific spray pattern. Two types of sprinklers that are commonly known and used are turret sprinklers and oscillator sprinklers.

As shown in FIG. 1, conventional oscillator sprinklers 100 typically contain a bar 115 containing a series of small nozzles 112. With the bend in the bar 115 and the nozzles 112 arranged in the illustrated manner, the oscillator sprinkler typically distribute the water in a generally uniform manner by spraying multiple streams of water out of the nozzles. The bar 115 rotates back and forth in an arc with the endpoints of the arc set by the operator, thereby covering a rectangular area.

Turret sprinklers operate in a different manner to distribute the water. As shown in FIG. 2, turret sprinklers 130 typically contain a plurality of nozzles 135 on a turret 140. Each nozzle contains a different nozzle configuration for a different distribution pattern of the water. To use a specific distribution pattern, the user rotates the turret 140 until the desired nozzle 135 (and accompanying distribution pattern) is selected.

Each of these types of sprinklers addresses a specific irrigation need by using a selected type of watering pattern desired by the operator/user. But to irrigate using both the watering patterns available to the oscillator sprinkler and the turret sprinkler, the user is required to purchase and operate each type of sprinkler separately. There exists no single device which combines both the capabilities of the turret and oscillator sprinklers.

### SUMMARY OF THE INVENTION

The invention relates to multi-functional irrigation devices and methods for using these devices in irrigation. The irrigation devices of the invention contain a part that operates substantially similar to a turret sprinkler and another part that operates substantially similar to an oscillator sprinkler. The device contains a mechanism for switching the function between the turret part and the oscillating part. The irrigation devices are thereby able to exhibit two modes of irrigation which can be used alternatively, saving the user time, effort, and costs.

### BRIEF DESCRIPTION OF THE DRAWINGS

The following description of the invention can be understood in light of the Figures, in which:

FIG. 1 depicts a conventional oscillator sprinkler;

FIG. 2 depicts a conventional turret sprinkler; and

FIGS. 3-5 depict the irrigation device in one aspect of the invention;

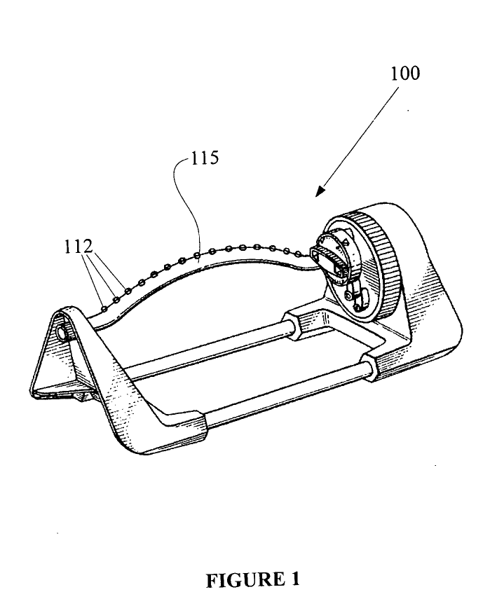

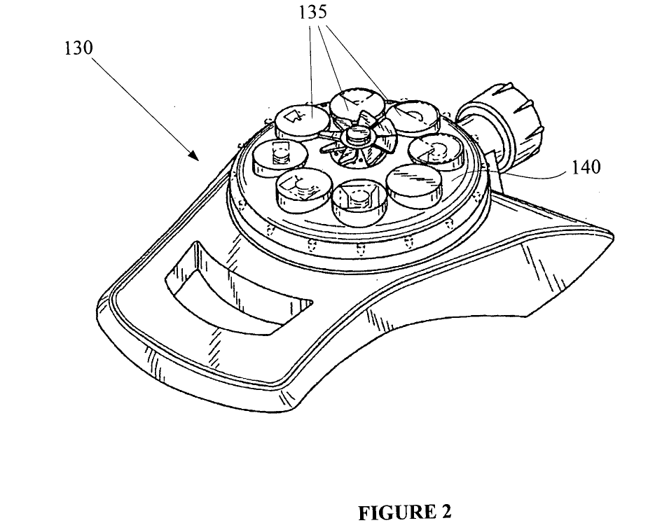

FIGS. 1-5 illustrate specific aspects of the invention and are a part of the specification. In the Figures, the thickness and configuration of components may be exaggerated for clarity. The same reference numerals in different drawings represent the same component. Together with the following description, the Figures demonstrate and explain the principles of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated method and resulting product and can be used in conjunction with apparatus and techniques conventionally used in the industry. While the invention is described for use as a sprinkler, it could be used for any other irrigation purpose.

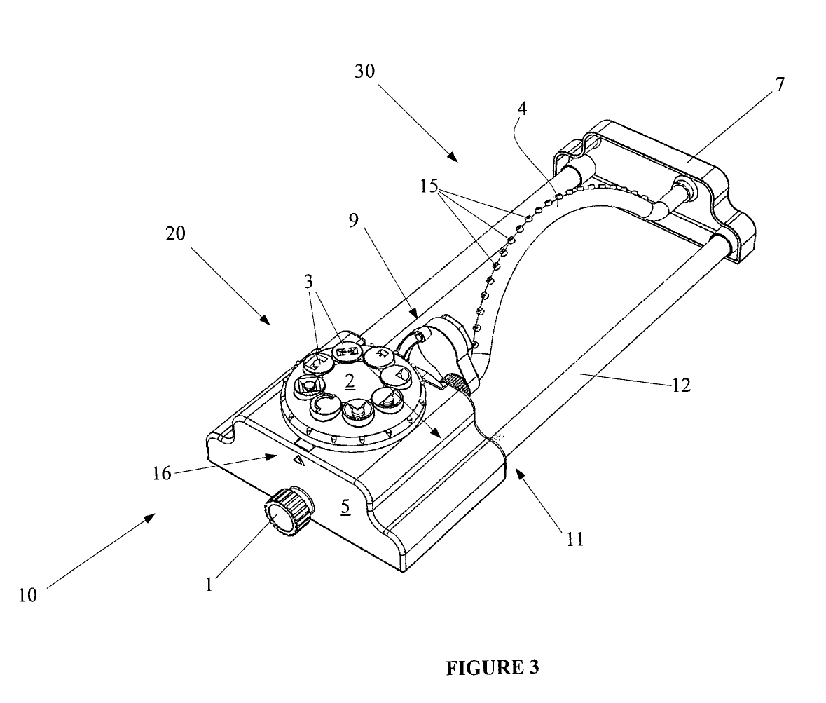

As described above, the invention includes irrigation devices that contain a portion that operates substantially similar to a turret sprinkler and another portion that operates substantially similar to an oscillator sprinkler. Any irrigation device operating in this manner is included within the invention. In one aspect of the invention, the irrigation devices of the invention are depicted in FIGS. 3-5.

In FIGS. 3-5, the irrigation device 10 contains two parts or portions. A first portion 20 of the irrigation device 10 comprises a means for performing a turret sprinkling function. A second portion 30 of the irrigation device 10 comprises means for performing an oscillator sprinkling function. The irrigation device 10 also contains means for switching the operation of the device 10 between the turret sprinkling function and the oscillator sprinkling function.

The irrigation device 10 contains a base 11 that supports the device 10 in a stable manner during operation. Any base known in the art can be used for this supporting function. In one aspect of the invention, the base 11 comprises a plurality of rails 12 that are connected at one end to a retaining support 7 and at the other end to a turret support 5. While any number of rails 12 can be used, typically just two are used in the irrigation device 10.

The irrigation device 10 also contains an oscillator bar 4. Oscillator bar 4 is substantially similar to similar mechanisms currently used in conventional oscillator sprinklers. Oscillator bar 4 is rotatably connected at one end to the retaining support 7 so that it can oscillate in an arc selected by the user. At the other end, the oscillator bar 4 is connected to rotating connecting means, which is in turn connected to the turret support 5. The rotating connecting means rotates the oscillator bar 4 in an arc while stabilizing and supporting the bar 4. As well, the rotating connecting means routes the water from the turret support 5 into the sprinkling arm 4. Any component known in the art that operates in this manner can be used in irrigation device 10, including any of those conventionally known as well as the rotating connector 9 depicted in FIGS. 3-5.

The irrigation device 10 contains any water inlet means conventionally known in the art. When the water comes from a conventional garden hose with a male fitting, the inlet means comprises any corresponding female fitting known in the art, including fitting 1. While the inlet means can be located anywhere in the device 10, it is usually placed on the position of turret support 5 indicated in FIG. 3.

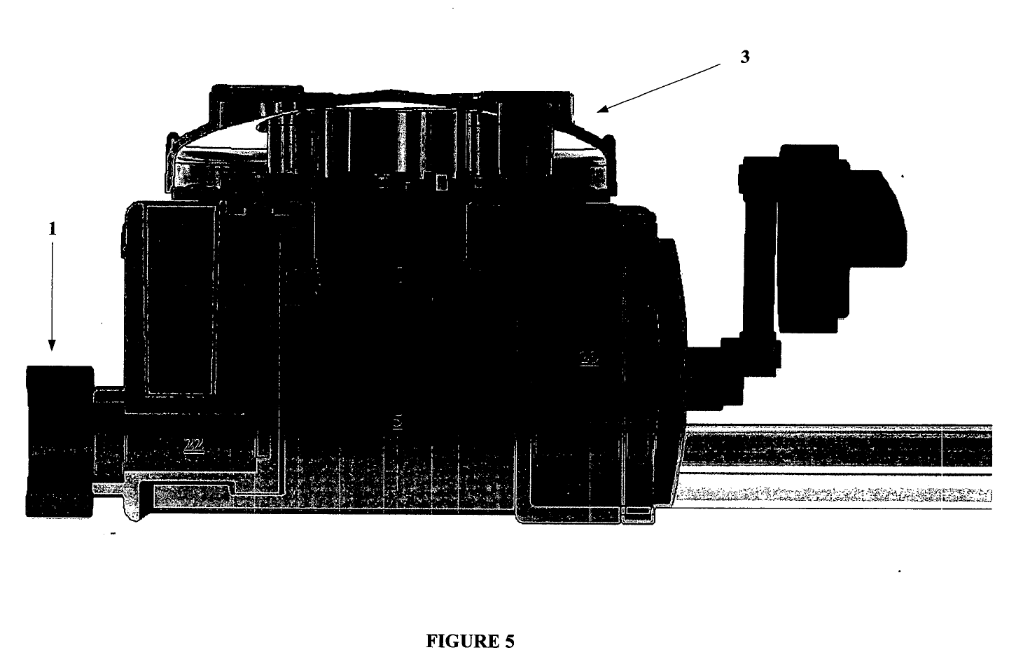

The turret support 5 contains means for routing the water from the inlet means (fitting 1) to the rotating connector 9. In one aspect of the invention, the turret support 5 contains both means for routing the water from the inlet means (i.e., fitting 1) to the turret 2 and from the turret to the rotating connector 9. Any routing means that operates in this manner can be used in the irrigation device. In one aspect of the invention, and as depicted in FIG. 5, the routing means comprises internal chamber 22 for routing the water from the inlet fitting 1 to the turret 2, as well as internal chamber 23 for routing the water from the turret 2 to the rotating connector 9.

As described above, the turret support 5 connects to and supports the plurality of rails 12 and the rotating connector 9. As well, the turret support 5 supports the turret 2 and contains the routing means described above. Along with the retaining support 7, the turret support 5 also supports and stabilizes the irrigation device 10. Accordingly, the turret support 5 can be configured with any size and shape that carries out these functions, including that depicted in FIG. 3.

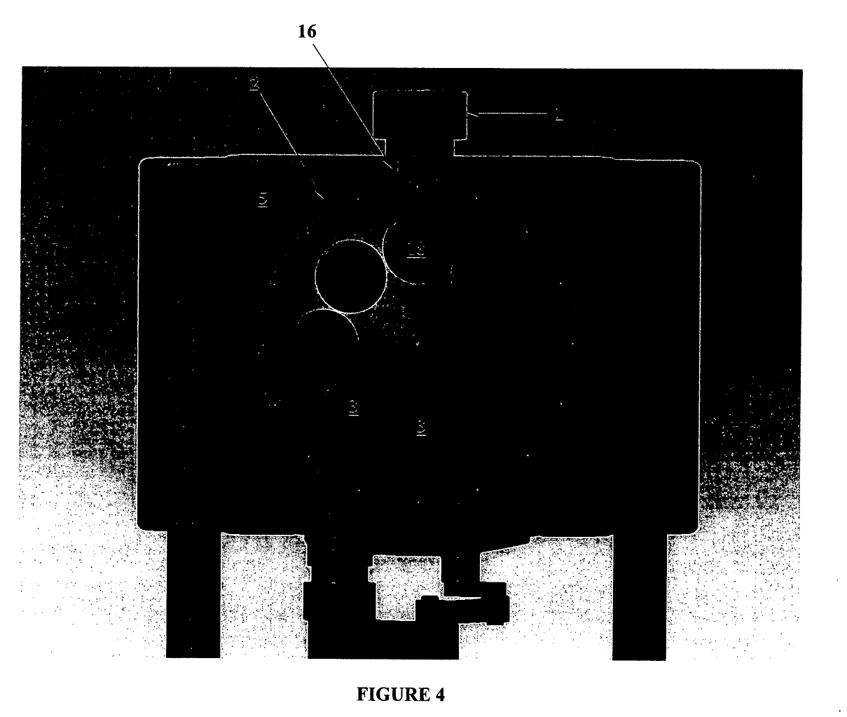

As shown in FIG. 4, the turret 2 contains various types of nozzles 3 having different distribution characteristics, i.e., different spray patterns. The turret 2 can have any number of nuzzles 3 with any number of different spray patterns. In the aspect of the invention illustrated FIG. 4, the turret 2 is illustrated with 7 different nozzles with the spray pattern shown on the nozzle. Other spray patterns could be used instead of those illustrated.

The turret 2 rotates so that different nozzles 3 (along with the accompanying spray pattern) can be selected by a user. Typically, and as illustrated in FIG. 4, the nozzle that is selected by the user is that nozzle closest to the inlet means. This position can optionally be indicated by using the mark 16 as a visual aid.

The turret 2 also contains an area 18 that does not contain a nozzle. When this area 18 (or position) of the turret 2 is selected by the user, no water can exit from the turret since there is no nozzle. Instead, this selection indicates that the oscillator function of the device 10 has been selected. With that selection, and as illustrated in FIG. 5, the water is blocked from exiting the turret 2. Instead, the water is routed through the turret 2 and into the internal chamber 23, through the rotating connector 9, and into the oscillator bar 4.

The irrigation devices of the invention can be modified to contain additional or optional features, including any of those described in the documents mentioned above. For example, the irrigation devices can contain any known feature that enhances its turret sprinkling function or its oscillator sprinkling function.

The irrigation devices of the invention can also be made as part of an irrigation system. Other components of an irrigation system could include the mechanism for flowing the water to the irrigation device (i.e., a garden hose), extension hoses, replacement parts, and/or tools.

The irrigation devices of the invention can be used like any other sprinkler known in the art, i.e., to water a lawn or other area. The advantage of the irrigation device of the invention is that it performs both the functions of an oscillator sprinkler and a turret sprinkler. The operator does not have to switch the hose from one sprinkler to another to change the sprinkling function, thereby increasing the efficiency of the irrigation process and reducing the operator's time, effort, and costs for irrigation. Rather, the user need only turn the turret from the oscillator position to the nozzle with the desired spray pattern (or vice versa). With a nozzle selected, the water flows from the inlet fitting 1, through the internal chamber 22, and out the desired nozzle. When the oscillator position is selected, there is no nozzle from which the water can exit the turret and the water is forced to flow into internal chamber 23, into the rotating connector 9, and then into the oscillator bar.

The irrigation devices of the invention can be made by any process that provides the structure described above. In one aspect of the invention, the conventional components of the irrigation device are obtained using conventional manufacturing methods. The turret support 5 is then manufactured using any known method that will provide the desired shape, including molding techniques, with the internal chambers and turret as depicted in FIG. 5. The turret is manufactured as conventionally known, with the exception that one specific area of the turret is left without a nozzle.

In addition to any previously indicated variation, numerous other modifications and alternative arrangements may be devised by those skilled in the art without departing from the spirit and scope of the invention and appended claims are intended to cover such modifications and arrangements. Thus, while the invention has been described above with particularity and detail in connection with what is presently deemed to be the most practical and preferred aspects of the invention, it will be apparent to those of ordinary skill in the art that numerous modifications, including but not limited to, form, function, manner of operation and use may be made without departing from the principles and concepts set forth herein.

What is claimed is:

1. An irrigation device, comprising a turret sprinkling portion and an oscillator sprinkling portion.

2. The device of claim 1, further comprising means for switching the operation between the turret sprinkling portion and the oscillator sprinkling portion.

3. The device of claim 2, wherein the switching means comprises a chamber between the turret sprinkling portion and an oscillator sprinkling portion.

4. The device of claim 3, wherein the turret sprinkling portion comprises a turret with a plurality of nozzles and an area without a nozzle.

5. The device of claim 4, wherein water flows from an inlet in the device, into the turret, and out a given nozzle selected by the user.

6. The device of claim 5, wherein selecting the area of the turret without a nozzle prevents the water from exiting the turret.

7. The device of claim 6, wherein the water is forced to flow from the turret and through the chamber and into the oscillator sprinkling portion.

8. The device of claim 7, wherein the oscillator sprinkling portion contains an oscillator bar with a plurality of nozzles.

9. The device of claim 8, wherein the water is forced to flow through the oscillator bar and out the plurality of nozzles.

10. An irrigation device, comprising:
a turret sprinkling portion;
an oscillator sprinkling portion; and
means for switching between the turret sprinkling portion and the oscillator sprinkling portion comprising a chamber therebetween.

11. The device of claim 10, wherein the turret sprinkling portion comprises a turret having a plurality of nozzles and an area without a nozzle and the oscillator sprinkling potion contains an oscillator bar with a plurality of nozzles.

12. The device of claim 11, wherein water flows from an inlet in the device, into the turret, and out a given nozzle selected by the user.

13. The device of claim 12, wherein selecting the area of the turret without a nozzle prevents the water from exiting the turret and forces the water to flow through the chamber, through the oscillator bar, and out the plurality of nozzles.

14. An irrigation device, comprising:
a turret sprinkling portion containing a turret having a plurality of nozzles and an area without a nozzle;
an oscillator sprinkling portion containing an oscillator bar with a plurality of nozzles;
means for switching between the turret sprinkling portion and the oscillator sprinkling portion comprising a chamber between the turret sprinkling portion and the oscillator sprinkling portion.

15. An irrigation system containing an irrigation device, the device comprising:
a turret sprinkling portion;
an oscillator sprinkling portion; and
means for switching between the turret sprinkling portion and the oscillator sprinkling portion comprising a chamber therebetween.

16. The system of claim 15, wherein the turret sprinkling portion comprises a turret having a plurality of nozzles and water flows from an inlet in the device, into the turret, and out a given nozzle selected by the user.

17. The system of claim 16, wherein selecting the area of the turret without a nozzle prevents the water from exiting the turret and forces the water to flow through the chamber and into the oscillator sprinkling portion.

18. A method for making an irrigation device, comprising:
providing a turret sprinkling portion;
providing an oscillator sprinkling portion; and
providing means for switching between the turret sprinkling portion and the oscillator sprinkling portion.

19. A method for irrigation, comprising:
providing an irrigation device containing a turret sprinkling portion, an oscillator sprinkling portion, and means for switching between the turret sprinkling portion and the oscillator sprinkling portion; and
providing the irrigation device with water.
